(19) United States
(12) Patent Application Publication
(10) Pub. No.: US 2019/0299909 A1
(43) Pub. Date: Oct. 3, 2019

(54) INFLATABLE CONTROL APPARATUS AND DEPLOYMENT METHOD THEREOF

(71) Applicants: GM GLOBAL TECHNOLOGY OPERATIONS LLC, Detroit, MI (US); The Regents of the University of Michigan, Ann Arbor, MI (US)

(72) Inventors: Paul W. Alexander, Ypsilanti, MI (US); Nancy L. Johnson, Northville, MI (US); Scott D. Thomas, Novi, MI (US); Diann Brei, Milford, MI (US); Jonathan E. Luntz, Ann Arbor, MI (US); Wonhee M. Kim, Royal Oak, MI (US); Zhaoxin Hu, Ann Arbor, MI (US); Laura Alejandra Giner Munoz, Ann Arbor, MI (US)

(21) Appl. No.: 16/114,423

(22) Filed: Aug. 28, 2018

Related U.S. Application Data
(60) Provisional application No. 62/649,956, filed on Mar. 29, 2018.

(51) Int. Cl. B60R 21/233; B60R 21/2334; B60R 21/015

(52) U.S. Cl. CPC B60R 21/233; B60R 21/2334; B60R 2021/23332; B60R 21/01516; B60R 21/01566

(57) ABSTRACT

An inflatable control apparatus and deployment method thereof are provided. The apparatus includes an inflatable unit configured to receive and hold air pressure, a first rigid planar cap disposed at a first end of the inflatable unit, and a second rigid planar cap disposed at a second end of the inflatable unit.

### INTRODUCTION

Apparatuses and methods consistent with exemplary embodiments relate to controls. More particularly, apparatuses and methods consistent with exemplary embodiments relate to vehicle controls.

### SUMMARY

One or more exemplary embodiments provide an inflatable control apparatus and a deployment method thereof. More particularly, one or more exemplary embodiments provide an inflatable control apparatus with rigid end members and an optional tensegrity structure configurable to control a vehicle or vehicle device and a method to deploy the inflatable control apparatus.

According to an aspect of an exemplary embodiment, an inflatable control apparatus is provided. The apparatus includes an inflatable unit configured to receive and hold air pressure, a first rigid planar cap disposed at a first end of the inflatable unit; and a second rigid planar cap disposed at a second end of the inflatable unit.

The inflatable unit may include a plurality of inflatable units, a plurality of first rigid planar caps disposed at a first end of the plurality of inflatable units, and a plurality of second planar caps disposed at a second end of the plurality of inflatable units, and the plurality of inflatable units may be attached to each other via one or more from among the plurality of first and second rigid planar caps.

The inflatable unit may further include a tensegrity structure configured to be tensioned into a rigid state after inflatable unit is inflated with the air pressure. The tensegrity structure may a stable three-dimensional contiguous structure when in the rigid state.

The tensegrity structure may include rigid linear shaped segments connecting a face of the first rigid planar cap facing toward the inflatable unit and a face of the second rigid planar cap facing toward the inflatable unit. The rigid linear shaped segments may be configured to constrain axial motion of the inflatable unit. Further, the rigid linear shaped segments may be configured to constrain one or more from among extension, compression, bending, torsion, or shearing of the inflatable unit. In addition, the rigid linear shaped segments may include at least one from among four wire segments, eight wire segments, and sixteen wire segments.

The apparatus of may include an air pump configured to inflate the in the inflatable unit, and a controller configured to control the air pump to inflate the inflatable unit.

The controller may be configured to control the air pump to inflate the inflatable unit to move the one or more from among a seat, a pedal, a table, a vehicle interior surface, and a vehicle exterior surface. The controller may also be configured to control the air pump to partially inflate the inflatable unit to deploy the one or more from among a seat, a pedal, a table, a vehicle interior surface, and a vehicle exterior surface in a reduced function deployment.

The apparatus of may include a vacuum, and the inflatable unit may include a steering wheel. The controller may be configured to control the air pump to inflate the inflatable unit when a vehicle is switched from an autonomous vehicle operating mode to a human driver controlled mode, and to control the vacuum to deflate the inflatable unit when a vehicle is switched from the human driver controlled mode to an autonomous vehicle operating mode.

The first rigid planar cap and the second rigid planar cap may be configured to seal the inflatable unit. In addition, at least one from among the first rigid planar cap and the second rigid planar cap may include a passage configured to receive air pressure to inflate the inflatable unit.

The inflatable unit may include at least one from among a sack, a bag, a bladder, and an elastic material in at least one from among a spherical shape and a cylindrical shape.

The apparatus of claim 1 may include a steering wheel, the inflatable unit may include a plurality of inflatable units, a plurality of first rigid planar caps disposed at a first end of the plurality of inflatable units, and a plurality of second rigid planar caps disposed at a second end of the plurality of inflatable units, the plurality of inflatable units may be attached to each other via the plurality of first and second rigid planar cap to comprise a stalk of the steering wheel, and the stalk of the steering wheel is connected may be the steering wheel.

The inflatable unit may include a sensor configured to detect movement or deformation of the inflatable unit, and the apparatus may a controller configured to receive a signal or information corresponding to the torsion detected by the sensor and control a vehicle function based on the received signal. The vehicle function may be a steering function.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of an inflatable control apparatus according to an exemplary embodiment;

FIGS. 2A and 2B show flowcharts for deployment and retraction methods of an inflatable control apparatus according to aspects of an exemplary embodiment;

FIG. 3 shows illustrations of an inflatable control apparatus configured to control steering of a vehicle according to an aspect of an exemplary embodiment;

FIG. 4 is an illustration showing deployment of inflatable units of an inflatable control apparatus according to an aspect of an exemplary embodiment;

FIG. 5A shows illustrations of various inflatable units of an inflatable control apparatus according to aspects of an exemplary embodiment;

FIG. 5B shows illustrations of wires attached to the caps of an inflatable control apparatus according to aspects of an exemplary embodiment;

FIG. 6 shows an illustration of a sensor built into an inflatable unit according to an aspect of an exemplary embodiment; and

FIG. 7 shows two inflatable units in inflated and deflated or retracted states according to aspects of an exemplary embodiment.

### DETAILED DESCRIPTION OF EXEMPLARY EMBODIMENTS

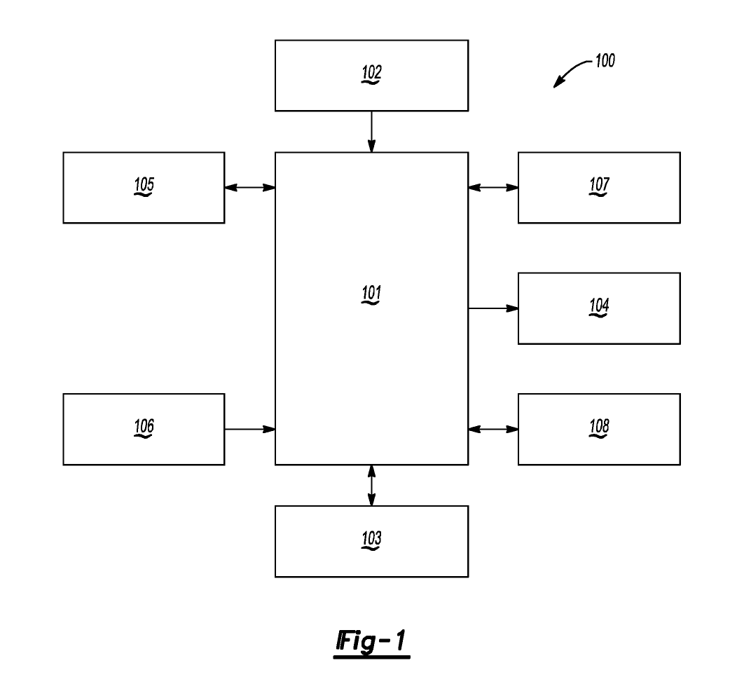

An inflatable control apparatus and deployment method thereof will now be described in detail with reference to FIGS. 1-7 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or into one or more devices. In addition, individual elements may be provided on separate devices.

Vehicles are being equipped with automated or autonomous control systems. These systems are designed to take over aspects of controlling a vehicle from a human driver. For example, automated or autonomous control systems may control steering, braking, windshield wipers, HVAC systems, charging systems, etc. When a vehicle is operating in automated or autonomous control mode, human controlled input devices may not be needed. For example, a steering wheel, an accelerator pedal, a brake pedal may not be used because their functions are being performed by automated or autonomous vehicle controls. Thus, the presence of these control devices may unnecessarily take up space.

One way of addressing this issue is to use inflatable control devices. The ability to inflate and deflate control devices allows them to be stored compactly when deflated and not in use. Moreover, inflatable control devices may be deployed quickly and take the shape of vehicle controls to allow a human driver to control a vehicle when necessary. However, inflatable devices may also need sufficient structural support to enable a human to apply an appropriate force to control mechanical or electrical components of a vehicle without damaging the inflatable control device.

FIG. 1 shows a block diagram of an inflatable control apparatus 100 according to an exemplary embodiment. As shown in FIG. 1, the inflatable control apparatus 100, according to an exemplary embodiment, includes a controller 101, a power supply 102, a storage 103, an output 104, an inflatable control device 105, a user input 106, vehicle controls 107 and a communication device 108. However, the inflatable control apparatus 100 is not limited to the aforementioned configuration and may be configured to include additional elements and/or omit one or more of the aforementioned elements. The inflatable control apparatus 100 may be implemented as part of a vehicle, as a standalone component, as a hybrid between an on vehicle and off vehicle device, or in another computing device.

The controller 101 controls the overall operation and function of the inflatable control apparatus 100. The controller 101 may control one or more of a storage 103, an output 104, an inflatable control device 105, a user input 106, vehicle controls 107, and a communication device 108, of the inflatable control apparatus 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 is configured to send and/or receive information from one or more of the storage 103, the output 104, the inflatable control device 105, the user input 106, the vehicle controls 107, and the communication device 108 of the inflatable control apparatus 100. The information may be sent and received via a bus or network, or may be directly read or written to/from one or more of the storage 103, the output 104, the user input 106, the vehicle controls 107, and the communication device 108 of the inflatable control apparatus 100. Examples of suitable network connections include a controller area network (CAN), a media oriented system transfer (MOST), a local interconnection network (LIN), a local area network (LAN), wireless networks such as Bluetooth and 802.11, and other appropriate connections such as Ethernet.

The power supply 102 provides power to one or more of the controller 101, the storage 103, the output 104, the inflatable control device 105, the user input 106, the vehicle controls 107, and the communication device 108, of the inflatable control apparatus 100. The power supply 102 may include one or more from among a battery, an outlet, a capacitor, a solar energy cell, a generator, a wind energy device, an alternator, etc.

The storage 103 is configured for storing information and retrieving information used by the inflatable control apparatus 100. The storage 103 may be controlled by the controller 101 to store and retrieve information received from the vehicle controls 107 or the inflatable control device 105.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 outputs information in one or more forms including: visual, audible and/or haptic form. The output 104 may be controlled by the controller 101 to provide outputs to the user of the inflatable control apparatus 100. The output 104 may include one or more from among a speaker, audio, a display, a centrally-located display, a head up display, a windshield display, a haptic feedback device, a vibration device, a tactile feedback device, a tap-feedback device, a holographic display, an instrument light, an indicator light, a user provided device such as a mobile device, a cell phone or a computer, etc.

The output 104 may output notification including one or more from among an audible notification, a light notification, and a display notification. The notification may include information notifying of the deployment and/or retraction of the inflatable control device 105 and the activation and/or deactivation of the devices that the inflatable control device 105 is positioning. The output 104 may also output a displayed graphic or indicator corresponding to the function of vehicle control 107 function being controlled by the inflatable control device 105 in response to the inflatable control device 105 being activated. For example, a steering wheel engagement indicator, an airbag enabled indicator, a volume indicator, a braking indicator, a speed indicator, or a climate control status, speed, or temperature indicator.

The inflatable control device 105 may include one or more from among an inflatable unit, a structure configured to make the inflatable control device rigid when inflated, an inflator such as a pump, a deflator such as vacuum, and a sensor configured to detect movement and/or deformation of the inflatable control device and output information corresponding to the movement/deformation of the inflatable control device. The inflatable control device 105 may be used to position one or more devices embodying one or more from among a steering wheel, a pedal, a shifter, a knob, a control stalk, a joystick, a button, etc.

The user input 106 is configured to provide information and commands to the inflatable control apparatus 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a touchpad, a user provided device such as a cell phone or a computer, etc. The user input 106 may be configured to receive a user input to acknowledge or dismiss the notification output by the output 104. The user input 106 may also be configured to receive a user input to activate or deactivate the inflatable control apparatus 100.

The vehicle controls 107 may include one or more from among a plurality of actuators, motors, fuel injectors, pumps, hydraulics configured to control vehicle steering, braking, acceleration, HVAC systems, electrical systems, signaling systems, infotainment systems, etc. Vehicle controls 107 may also include autonomous sensors to control transitions between automated driving and manual driving. These sensors can monitor the occupant as well as road, environmental, and vehicle conditions and output information used to deploy or retract the steering wheel and disable or enable its usage/functionality.

The communication device 108 may be used by inflatable control apparatus 100 or the devices which it is positioning to communicate with several types of external apparatuses according to various communication methods. The communication device 108 may be used to send/receive various information such as information on operation mode of the vehicle and control information for operating vehicle controls to/from the controller 101 of the inflatable control apparatus 100. It can also send/receive information corresponding to occupant position and occupant attention.

The communication device 108 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long-term evolution (LTE), Bluetooth, EVDO, CDMA, GPRS, EDGE or ZigBee. In addition, the communication device 108 can interface with occupant detection and occupant attention sensing systems via hard wired connections or wireless connections within the vehicle.

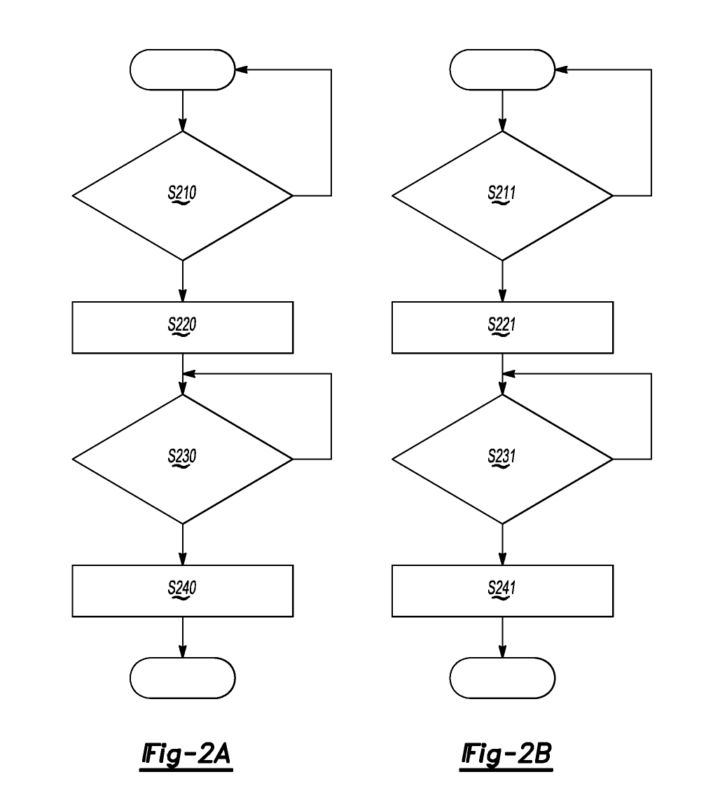

FIGS. 2A and 2B show flowcharts for deployment and retraction methods of an inflatable control apparatus according to aspects of an exemplary embodiment. The methods of FIGS. 2A and 2B may be performed by the inflatable control apparatus 100 or may be encoded into a computer readable medium as instructions that are executable by a computer to perform the method.

Referring to FIG. 2A, a change from autonomous or automated control mode is checked for in operation S210. If the change is detected in operation S210—Yes, an inflatable control device is deployed in operation S220. In operation S230, it is determined whether the inflatable control device is fully deployed and the driver has engaged the steering wheel on the inflatable control device. If it is determined that the inflatable control device is fully deployed and the driver has engaged the steering wheel on the inflatable control device (operation S230—Yes), the inflatable control device is activated and the vehicle controls are switched to human driver control mode in operation S240.

Referring to FIG. 2B, a change from manual driving mode to autonomous driving mode is checked for in operation S211. If the change is detected in operation S211—Yes, an inflatable control device is retracted in operation S221. In operation S231, it is determined whether the inflatable control device is fully retracted and the automated controls have engaged the vehicle steering system. If it is determined that the inflatable control device is fully retracted and the automated controls have engaged the steering system (operation S231—Yes), the inflatable control device is retracted and the vehicle controls are switched to automated control mode in operation S241.

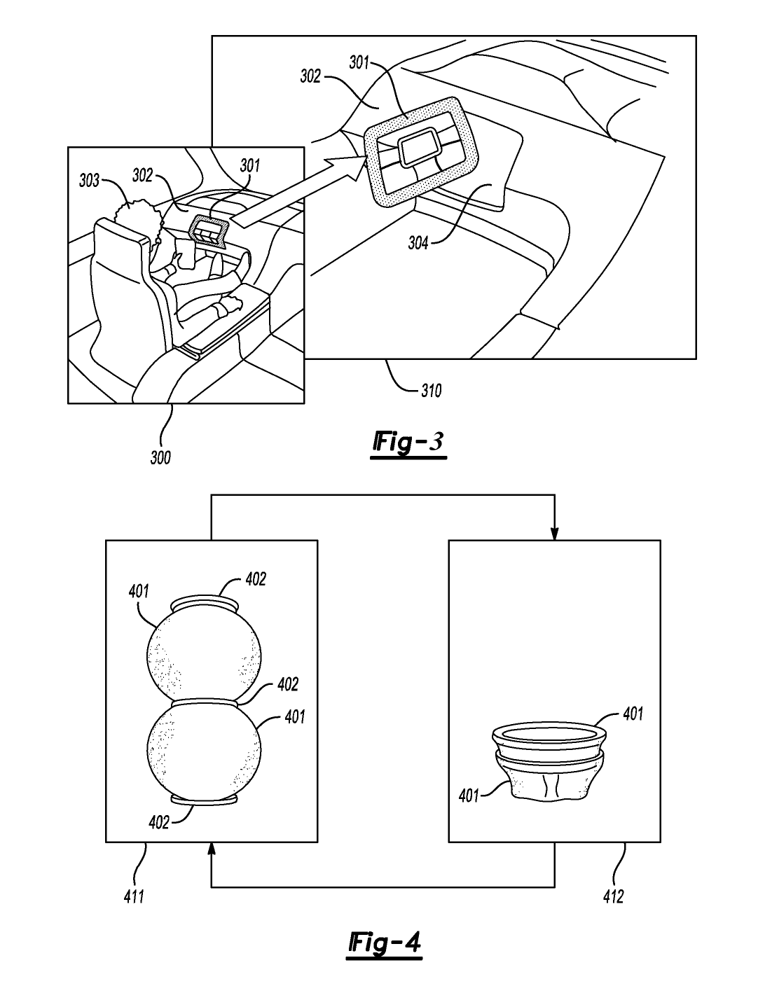

FIG. 3 shows illustrations of an inflatable control apparatus configured to control steering of a vehicle according to an aspect of an exemplary embodiment.

Referring to FIG. 3, an inflatable control device 105 embodying a steering wheel 301 is deflated and stored in a compartment or recess 304 in a vehicle dashboard 302 as shown in illustration 300. As shown in illustration 300, a passenger 303 may have more space to perform tasks such as reading or more legroom. In illustration 310, the steering wheel 301 is shown in the inflated position 300. The steering wheel 301 extends from the recess or storage compartment 304 after being inflated enabling a passenger to reach, grab and control the steering wheel 301 and control the vehicle if necessary.

In one example, the inflatable system may also be nominally accessible in the stowed configuration so that it is available, potentially in a reduced-size, deflated, or partially inflated configuration, for user input in this state. This could allow for access in time sensitive situations where full deployment may not be able to be achieved. In this state, a reduced control configuration may be accessible by a user.

The deployable inflatable system may also extend to include the deployment, stowing, articulation, morphing of the surrounding surfaces and structures to which the control device or devices are attached. For example, surrounding surfaces and structures may be inflated, deflating, or moved using the inflator or other inflatable units to deploy or retract the system.

FIG. 4 is an illustration showing deployment of inflatable units of an inflatable control apparatus according to an aspect of an exemplary embodiment.

Referring to FIG. 4, inflatable units 401 of an inflatable control device 105 of inflatable control apparatus 100 are shown. The inflatable units 401 are held together by planar caps, discs or cylindrical shaped separators 402 that are disposed at the ends and in between inflatable units 401. As shown in FIG. 4, the inflatable control device 105 is filled with air and expands when deployed 411. When the inflatable control device 105 is not being used, it may be deflated as it returned to a state to enable storage as shown in illustration 412.

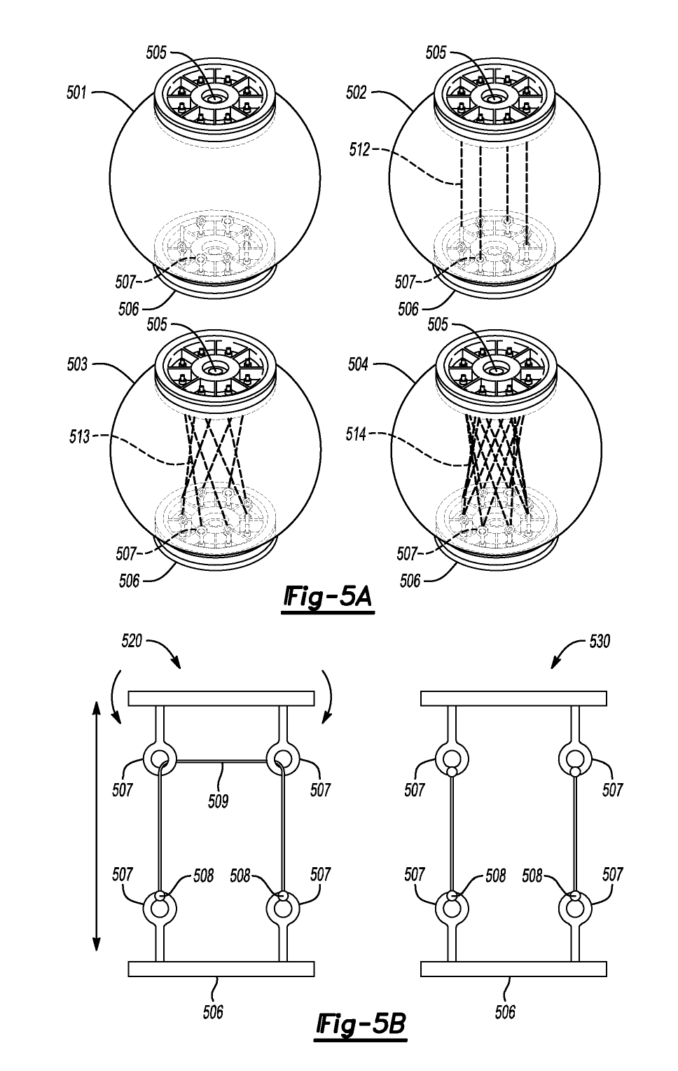

FIG. 5A shows illustrations of various inflatable units of an inflatable control apparatus according to aspects of an exemplary embodiment.

Referring to FIG. 5A, various configurations of inflatable units 401 are shown. The shown configurations include an inlet/outlet hole for inflation/deflation and a planar caps, discs or cylindrical shaped endcaps or separators 506. However, the inlet/outlet hole is optional and an inflator may be disposed in the inflatable unit 401, thereby making the inlet/outlet unnecessary in the case of a single inflatable unit structure. Loops 507 or hooks (not shown) are optional and are used to attach the tensegrity structure to the separators 506. Other mechanical attachments are possible such as threaded fasteners, adhesives, welds, snap-fits, etc.

The tensegrity structure become rigid when expanded as the inflatable unit 401 is inflated. The tensegrity structure restricts motion and/or deformation of an inflatable unit 105 in one or more degrees of freedom or modes of deformation. For example, motion or deformation that may be restricted includes, but is not limited to, extension, compression, bending, torsion, shearing, etc.

The first configuration 501 does not comprise a tensegrity structure. A tensegrity structure may include linear rigid segments such as strings, straps, monofilaments, ropes, cables, braids, etc. Examples of tensegrity structures include the second configuration 502 includes a 4-wire segment 512 tensegrity structure. The second configuration is configured to constrain axial motion, extension, and/or compression. The third configuration 503 includes an 8-wire segment 513 tensegrity structure with the wires being continuously weaved. The third configuration is configured to constrain torsion and prevent extension and compression of the inflatable unit. The fourth configuration 504 includes a 16-wire segment 514 tensegrity structure with the wires being continuously weaved. The fourth configuration is configured to further constrain torsion and prevent extension and compression of the inflatable unit.

FIG. 5B shows illustrations of wires attached to the caps of an inflatable control apparatus according to aspects of an exemplary embodiment.

Referring to FIG. 5B, the wires can be implemented in multiple ways, providing different constraints on the relative motion of the end caps. The linear segments or wires connecting both caps may be attached in a manner that they are fixed or can slide such that depending on how they are attached to the endcaps. Depending on the manner of attachment, some of the relative movements of the caps are restricted such as rotation.

In one example 530 in FIG. 5B, the ends of 2 parallel, equal length wires are connected to fixed attachment points 508 separately to different loops 507 on each end cap 506. In this configuration, when the wires are under tension, the upper cap can move in shear (side-to-side) relative to the top cap, but cannot move axially away from the bottom cap and cannot move in rotation in the plane of the drawing (i.e., it must remain parallel to the bottom cap).

In another example 520, one continuous wire, the ends of which are connected to the bottom cap 506 by fixed attachment points 508, but can pass freely 509 through loops 507 in the upper cap, is shown. The upper cap, while still constrained from moving axially away from the lower cap, can both move in shear as before as well as rotating in the plane of the drawing. This extra degree of freedom is gained by using looped pass-through attachment point on one cap for one long continuous wire rather than fixed attachment points 508 for two separate wires on both caps.

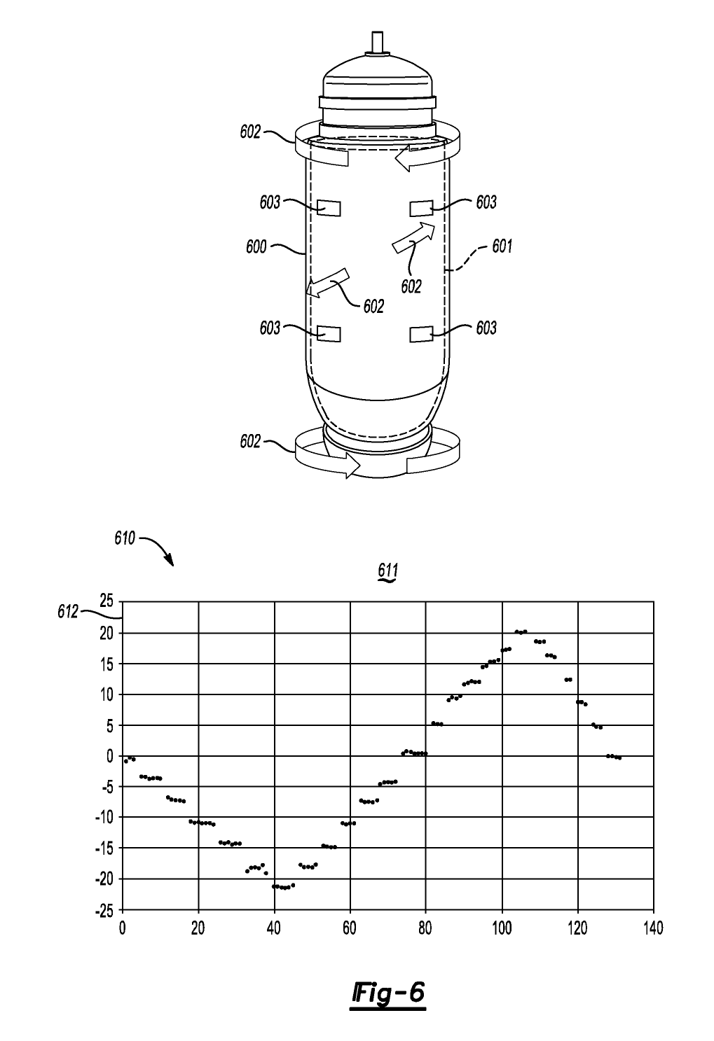

FIG. 6 shows an illustration of a sensor built into an inflatable unit according to an aspect of an exemplary embodiment.

Referring to FIG. 6, an inflatable control apparatus 105 in the form of a cylindrical bladder or stalk 600 is shown. The cylindrical bladder or stalk 600 may turned, twisted or a torsion force 602 may be applied in one or more directions. For example, a clockwise direction, a counter-clockwise direction, etc. The application of the force 602 in one or more directions affects the electrical signal that travels through the cylindrical bladder or stalk 600, as measured by one or more sensors, thereby indicating an input applied by an operator to the inflatable control apparatus 105. Thus, the movement or deformation of the inflatable control apparatus 105 may be measured by the one or more sensors

An array of sensors properly configured could detect and discriminate between extension, compression, bending, torsion, and shearing of the unit, which may respectively correspond to different control signals and vehicle functions/operations. The sensors may be placed on an inner or outer cylinder wall or on a tensegrity element.

As shown in graph 610 showing a 180-degree torsion test 611, the sensor response signal 612 changes over time 613 as a torsion force is applied to the cylindrical bladder or stalk 600.

Modulation of the inflatable unit's or portion of the inflatable unit's pressure can enable tuning of the responsiveness and stiffness of the system as well as provide haptic feedback to the user. Further, the inflatable or tensegrity elements may be designed to resonate or amplify the haptic signals created by pressure modulation or an additional actuation element in order to better communicate with the user.

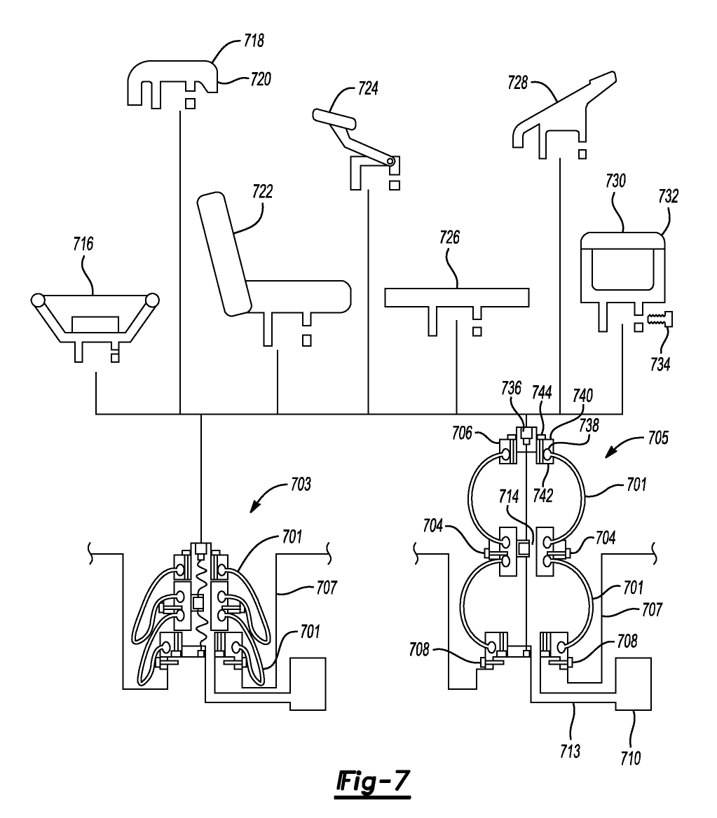

FIG. 7 shows two inflatable units in inflated and deflated or retracted states according to aspects of an exemplary embodiment.

Referring to FIG. 7, a cross-section of two inflatable units in a deflated state 703 and an inflated state 705 are shown. The inflatable units can be attached together with fasteners 704. The units can also attach to a recessed vehicle portion 707 via fasteners 708, e.g., a pin, a screw, etc. A pump and/or vacuum 710 can inflate and/or deflate the inflatable units via a fill tube 713 and a passage 714.

For each inflatable unit 701, the tensegrity structure 712 is attached to each planar cap or disc shaped separator 706 via a fastener 736 which could be a threaded fastener like a nut, a loop, a hook, etc. The bladders 701 are attached to each planar cap disc shaped separator 706 as the larger lip 738 of the bladders 701 are clamped between an outer separator 740 and an inner separator 742 via fasteners 744 which may be threaded bolts, pins, or other fastening device.

Some of the devices which can be deployed, moved, or retracted by the inflatable units 701 include a steering wheel 716, an exterior component of a vehicle 718 such as a bumper 720, a seat 722, a pedal assembly 724, a table 726, an exterior air foil 728, an interior component 730 such as a console 732. One or more fasteners 734 is used to attach these devices to the adjacent inflatable unit 701. The devices may be fully or partially stowed within the recessed vehicle portion 707 when the inflatable units 701 are in the retracted state.

The inflatable units can be stowed fully or partially within the recessed vehicle portion 707 when the inflatable units are in the retracted or deflated state. The recessed vehicle portion 707 can be stationary with respect to the vehicle or it could move with respect to the vehicle such as when a steering wheel 716 is turned. The inflatable units and the recessed vehicle portion 707 could also turn enabling the steering wheel 716 to transmit torque and rotation to the recessed vehicle portion 707.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. An inflatable control apparatus comprising:
an inflatable unit configured to receive and hold air pressure;
a first rigid planar cap disposed at a first end of the inflatable unit; and
a second rigid planar cap disposed at a second end of the inflatable unit.

2. The apparatus of claim 1, wherein the inflatable unit comprises a plurality of inflatable units, a plurality of first rigid planar caps disposed at a first end of the plurality of inflatable units, and a plurality of second planar caps disposed at a second end of the plurality of inflatable units, and
wherein the plurality of inflatable units are attached to each other via one or more from among the plurality of first and second rigid planar caps.

3. The apparatus of claim 1, wherein the inflatable unit further comprises a tensegrity structure configured to be tensioned into a rigid state after inflatable unit is inflated with the air pressure.

4. The apparatus of claim 3, wherein the tensegrity structure is a stable three-dimensional contiguous structure when in the rigid state.

5. The apparatus of claim 4, wherein the tensegrity structure comprises rigid linear shaped segments connecting a face of the first rigid planar cap facing toward the inflatable unit and a face of the second rigid planar cap facing toward the inflatable unit.

6. The apparatus of claim 5, wherein the rigid linear shaped segments are configured to constrain axial motion of the inflatable unit

7. The apparatus of claim 5, wherein the rigid linear shaped segments are configured to constrain one or more from among extension, compression, bending, torsion, or shearing of the inflatable unit.

8. The apparatus of claim 5, wherein the rigid linear shaped segments comprise at least one from among four wire segments, eight wire segments, and sixteen wire segments.

9. The apparatus of claim 1, further comprising:
an air pump configured to inflate the in the inflatable unit; and
a controller configured to control the air pump to inflate the inflatable unit.

10. The apparatus of claim 9, wherein the controller is configured to control the air pump to inflate the inflatable unit to move the one or more from among a seat, a pedal, a table, a vehicle interior surface, and a vehicle exterior surface.

11. The apparatus of claim 10, wherein the controller is configured to control the air pump to partially inflate the inflatable unit to deploy the one or more from among a seat, a pedal, a table, a vehicle interior surface, and a vehicle exterior surface in a reduced function deployment.

12. The apparatus of claim 9, further comprising a vacuum,
wherein the inflatable unit comprises a steering wheel,
wherein the controller is configured to control the air pump to inflate the inflatable unit when a vehicle is switched from an autonomous vehicle operating mode to a human driver controlled mode, and
wherein the controller is configured to control the vacuum to deflate the inflatable unit when a vehicle is switched from the human driver controlled mode to an autonomous vehicle operating mode.

13. The apparatus of claim 1, wherein the first rigid planar cap and the second rigid planar cap are configured to seal the inflatable unit.

14. The apparatus of claim 13, wherein at least one from among the first rigid planar cap and the second rigid planar cap comprise a passage configured to receive air pressure to inflate the inflatable unit.

15. The apparatus of claim 1, wherein the inflatable unit comprises at least one from among a sack, a bag, a bladder, and an elastic material.

16. The apparatus of claim 1, wherein the inflatable unit comprises at least one from among a spherical shape and a cylindrical shape.

17. The apparatus of claim 1, further comprising a steering wheel,
wherein the inflatable unit comprises a plurality of inflatable units, a plurality of first rigid planar caps disposed at a first end of the plurality of inflatable units, and a plurality of second rigid planar caps disposed at a second end of the plurality of inflatable units, and
wherein the plurality of inflatable units attached to each other via the plurality of first and second rigid planar cap to comprise a stalk of the steering wheel, and
wherein the stalk of the steering wheel is connected to the steering wheel.

18. The apparatus of claim 1, wherein the inflatable unit comprises a sensor configured to detect movement or deformation of the inflatable unit.

19. The apparatus of claim 18, further comprising a controller configured to receive a signal or information corresponding to the torsion detected by the sensor and control a vehicle function based on the received signal.

20. The apparatus of claim 19, wherein the vehicle function comprises a steering function.
